(19) United States
(12) Patent Application Publication
(10) Pub. No.: US 2006/0236914 A1
(43) Pub. Date: Oct. 26, 2006

(54) Marker for trails, routes and the like having sponsorship indicia thereon and method of use

(76) Inventor: Greg Willett, Fishers, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/400,899

(22) Filed: Apr. 10, 2006

Related U.S. Application Data
(60) Provisional application No. 60/670,488, filed on Apr. 12, 2005.

(51) Int. Cl. G01D 21/00

(52) U.S. Cl. 116/209

(57) ABSTRACT

A marker is disclosed that encompasses any structure placed on a route to be followed (including, by way of example only and not of limitation, a roadway, hiking trail, biking trail, running course, boardwalk, etc.) that includes geographic indicia and sponsorship indicia. Geographic indicia include distance from or to a designated location such as the beginning or end of a course, or elevation relative to a reference such as altitude above sea level. Other types of geographic indicia are contemplated such as latitude and longitude as well as relative distance indicators such as “Mile 6 of 10” for example. Sponsorship indicia include (by way of example and not by way of limitation) sponsor name, sponsor logo, sponsor motto, sponsor advertisement, etc. Because the route exists to be followed by a number of people, the markers will be seen by a number of people during the course of a day.

### CROSS REFERENCE TO RELATED APPLICATION

The present application claims the benefit of Untied States Provisional Patent Application Ser. No. 60/670,488, filed Apr. 12, 2005, with said priority application being incorporated herein by reference in its entirety.

### TECHNICAL FIELD OF THE INVENTION

The present invention generally relates to markers for marking the mileage point on a pathway and, more particularly, to a marker for trails, routes and the like having sponsorship indicia thereon and a method of use of same.

### BACKGROUND OF THE INVENTION

It is conventionally known to place mile markers and the like along roadways, particularly interstate highways, biking paths, hiking trails, running race courses, etc., marking the distance traveled from a selected beginning point or the distance to a selected ending point. Such markers are typically erected by governmental agencies or race organizers, and represent an expense to be borne by such groups.

Consequently, there is a need for a mileage marker that exhibits a lower expense for such groups or, in fact, creates a source of revenue for such groups. The present invention is directed toward meeting this need.

### BRIEF DESCRIPTION OF THE DRAWINGS

FIG. 1 is a perspective view of a first embodiment marker of the present invention installed into the ground.

FIG. 2 is a flowchart showing an embodiment of a method of using a marker of the present invention.

### DETAILED DESCRIPTION OF THE PREFERRED EMBODIMENTS

For the purposes of promoting an understanding of the principles of the invention, reference will now be made to the embodiment illustrated in the drawings, and specific language will be used to describe that embodiment. It will nevertheless be understood that no limitation of the scope of the invention is intended. Alterations and modifications in the illustrated device, and further applications of the principles of the invention as illustrated therein, as would normally occur to one skilled in the art to which the invention relates are contemplated, are desired to be protected

The present invention comprehends the use of a portion of the surface area of a marker for placement of indicia of a sponsor thereon. As used herein, the term “marker” is intended to encompass any structure placed on a route to be followed (including, by way of example only and not of limitation, a roadway, hiking trail, biking trail, running course, boardwalk, etc.), whether or not such markers include geographic indicia such as distance from or to a designated location such as the beginning or end of a course, or elevation relative to a reference such as altitude above sea level. Other types of geographic indicia are contemplated such as latitude and longitude as well as relative distance indicators such as “Mile 6 of 10” for example. Because the route exists to be followed by a number of people, the markers will be seen by a number of people during the course of a day.

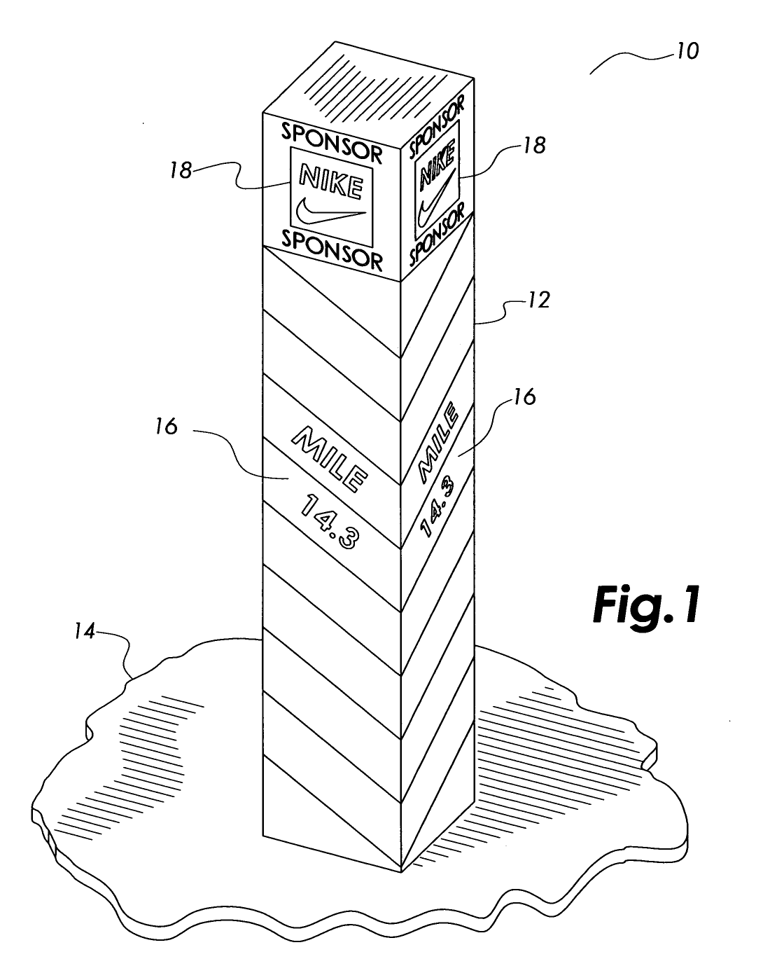

An embodiment of one such marker according to the present invention is illustrated in FIG. 1, and indicated generally at 10. The marker 10 in this embodiment is a post 12 embedded into the ground 14 and extending above the surface of the ground 14 to a height of four feet six inches. The post 12 is of square cross-section and has a cross-sectional diameter of fourteen inches. Such a marker may be placed along a route to signal to followers of the route not only the location of the route, but also geographic indicia such as the mileage from the marker to a selected beginning or ending point. To this end, the post 12 has printed thereon by any suitable means geographic indicia 16. The present invention comprehends that geographic indicia 16 may indicate, miles, meters, kilometers, feet, altitude, or any other locational measure.

In order to defray the expense of the marker 10, or to turn the marker 10 into a profit-generating object, the present invention comprehends solicitation of sponsorship for the marker in exchange for something of value, whether cash, credit or an in-kind item. In return, the sponsor may have its name and/or logo, or other suitable identifying information, placed upon the marker 10. By way of example, the marker 10 of FIG. 1 has sponsorship indicia 18 placed upon a surface thereof. As used herein, sponsorship indicia may include (by way of example and not by way of limitation) sponsor name, sponsor logo, sponsor motto, sponsor advertisement, etc.

In FIG. 1, the sponsor name NIKE®, as well as its famous “swoosh” logo has been applied to the marker 10 as the sponsorship indicia 18. In addition or in place thereof, the sponsorship indicia could include the motto JUST DO IT®, as this would serve as an inspirational message to those following the route and would also conjure up association with the Nike company in the viewer's mind.

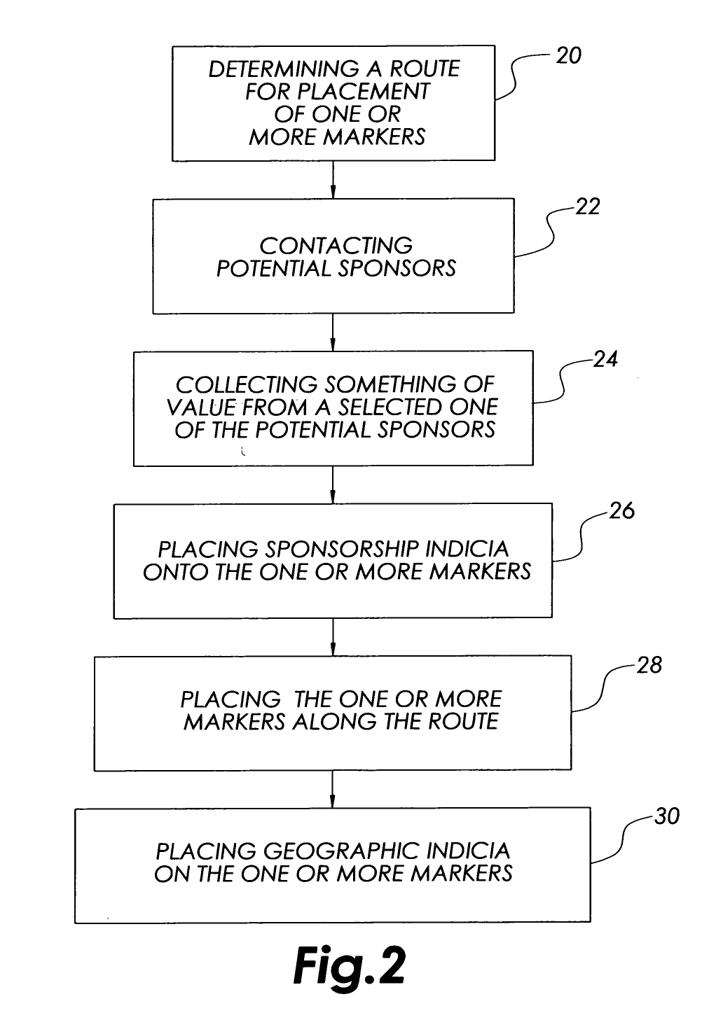

The present invention also comprehends a method of using the markers 10 shown in FIG. 2. Such method includes the steps of determining a route along which it is desired to place markers shown at 20, contacting potential sponsors who may be interested in placing sponsorship indicia 18 onto one or more markers along the route shown at 22, collecting something of value from a selected one of the potential sponsors shown at 24, placing sponsorship indicia of the one or more sponsors on one or more markers shown at 26, placing one or more markers along the route shown at 28, and placing geographic indicia on said one or more markers corresponding to the markers' geographic location shown at 30.

It will be appreciated by those skilled in the art that the markers of the present invention may be permanently placed along the route (such as by embedding them into the ground, affixing them to rocks, etc.), which would be appropriate for permanent or semi-permanent routes. Alternatively, the markers of the present invention may be temporarily placed along the route (such as by designing the markers to be freestanding upon a surface), which would be appropriate for temporary routes such as running race routes.

While the invention has been illustrated and described in detail in the drawings and foregoing description, the description is to be considered as illustrative and not restrictive in character. Only the preferred embodiment, and certain other embodiments deemed helpful in further explaining how to make or use the preferred embodiment, have been shown. All changes and modifications that come within the spirit of the invention are desired to be protected.

What is claimed is:

1. A signaling device comprising:
a marker;
geographic indicia on the marker; and
sponsorship indicia on the marker.

2. The signaling device of claim 1 wherein the sign is adapted to be temporarily placed along a route.

3. The signaling device of claim 1 wherein the marker is adapted to be permanently placed along a route.

4. The signaling device of claim 1 wherein the sponsorship indicia is selected from the group consisting of sponsor name, sponsor logo, sponsor motto, and advertisement.

5. The signaling device of claim 1 wherein the marker is a post.

6. The signaling device of claim 1 wherein geographic indicia is selected from the group consisting of distance, elevation, latitude, longitude, and relative distance.

7. A method of using a signaling device having geographic indicia relative to a larger set of geographic indicia, the method comprising the steps of:
a) determining a route for placement of at least one marker;
b) contacting potential sponsors who may be interested in placing sponsorship indicia along the route;
c) collecting something of value from a selected one of the potential sponsors;
d) placing sponsorship indicia onto the at least one marker for the selected sponsors;
e) placing the at least one marker along the route; and
f) placing geographic indicia on the at least one marker corresponding to the marker's geographic location.

8. The method of claim 7 wherein step e) comprises temporarily placing the marker along the route.

9. The method of claim 8 further comprising the step of removing the marker after a predetermined period of time.

10. The method of claim 7 wherein step e) comprises permanently placing the marker along the route.

11. The method of claim 7 wherein the something of value is selected from the group consisting of cash, credit and in-kind items.

12. The method of claim 7 wherein the geographic indicia indicates the relative distance of the marker from the beginning of the route.

13. The method of claim 7 wherein the geographic indicia indicates the relative distance of the marker to the end of the route.

14. The method of claim 7 wherein the sponsorship indicia is selected from the group consisting of sponsor name, sponsor logo, sponsor motto, and advertisement.

15. The method of claim 7 wherein the marker is a post.

16. The method of claim 7 wherein geographic indicia is selected from the group consisting of distance, elevation, latitude, longitude, and relative distance.
